(19) United States
(12) Patent Application Publication
(10) Pub. No.: US 2010/0145911 A1
(43) Pub. Date: Jun. 10, 2010

(54) Serverless Replication of Databases

(76) Inventors: Armin Germer, Berlin (DE); André Hacker, Hersbruck (DE)

Correspondence Address: IP STRATEGIES, 12 1/2 WALL STREET, SUITE E, ASHEVILLE, NC, 28801, US

(21) Appl. No.: 11/577,085

(22) PCT Filed: Oct. 12, 2005
(86) PCT No.: PCT/EP2005/010967

§ 371 Date: Dec. 8, 2009

(30) Foreign Application Priority Data
Oct. 12, 2004 (EP) 04024296.8

(51) Int. Cl. G06F 17/30

(52) U.S. Cl. 707/622; 707/E17.032

(57) ABSTRACT

The invention relates to a method for carrying out the serverless replication of databases. The inventive method is characterized in that: a copy of the database on at least one peer of the peer-to-peer computer network is modified; a synchronization request due to the modified copy of the database is generated on the at least one peer of the peer-to-peer computer network; the synchronization request is transmitted to all other peers of the peer-to-peer computer network; the synchronization request is received and executed by all the other peers, and; synchronization confirmations are generated after the execution of the synchronization request on each of the other peers and are communicated to all peers or to all peers with the exception of the peer that transmits the synchronization confirmation to the remaining peers.

### FIELD OF THE INVENTION

The present invention refers to a method for replicating databases in peer-to-peer structures.

### PRIOR ART

Present and future computer systems increasingly comprise architectures that are characterized in that both the processor as well as the memory components are distributed logically and particularly also physically on separate computer units.

While in conventional computer systems a hierarchical relation prevails between a central server system and a central database on the one hand and local clients with their own, to some extent read-only, databases on the other hand, peer-to-peer architectures in which a number of equal computer units exchange information collaboratively are of growing practical importance.

In such serverless environments the problem of efficient and possibly fault-tolerant synchronization of databases occurs of which any peer has a copy available which the peer can access but which it is also authorized to modify. If, however, each peer of a linked computer system has a modification authorization for one or several databases whose copy or copies can also be accessed by the other peers, and on the basis of data of these databases information is exchanged between the peers, the problem of data integrity necessarily arises, since for instance one or several users may modify simultaneously one or several of said databases.

Different strategies to control replication and thus synchronization of databases in serverless environments are known from the prior art. A distinction is made between synchronous and asynchronous replication strategies. In synchronous replication a modification procedure for the copies of the databases which are accessed by the remaining peers is normally initiated by the same transactions by means of which a user modifies a copy of the databases on his peer. The transaction can only apply as being terminated, and further transactions to modify the same database or other databases can only be made, if the initially performed modification was comprehended for all copies of the peer-to-peer system. Furthermore, it must be ensured in such a replication that all peers are online to avoid unreasonable delays.

First of all, modifications of the copies of a respective database are made by means of asynchronous replication methods, they are stored there and then forwarded to the other peers at a later date and adopted by them when they are online. In the asynchronous methods central databases (US 2002/0188624) or nodes (U.S. Pat. No. 5,261,094) which first of all collect all modifications referring to the copies of a database are used. Through this a certain dependency of the total system on a specific unit is introduced again, which compared to the classic server-client architectures shall exactly be avoided.

Solutions, which avoid at least conflicts resulting from different modifications of the same copies of existing databases, which were made by different peers, may be implemented according to the “proprietor principle”. In this case each database is allocated to a certain peer as primary copy and this copy may only be modified by this peer. Such a solution is, however, generally not practice-oriented, since modification requests of peers other than the proprietor must be communicated to this peer to be subsequently implemented by it.

Thus, there is a demand for improving known organization structures for the serverless database replication in a way that the fault-tolerant exchange of updated databases from peer to peer is enabled in a cost-effective, generally implementable and reliable manner, wherein it is preferred that information about possible conflicts, such as colliding modifications made by different users, is provided and advantageously used.

### DESCRIPTION

The above-mentioned object is solved by the method of the present invention according to claim 1. The inventive method for replicating databases in peer-to-peer computer networks comprises the following steps: modifying a copy of the database on at least one peer of the peer-to-peer computer network, generating a synchronization request due to the modified copy of the database on the at least one peer of the peer-to-peer computer network, transmitting the synchronization request to all other peers of the peer-to-peer computer network, receiving and executing the synchronization request on all other peers and generating and transmitting synchronization confirmations after executing the synchronization request on each of the other peers to all peers or to all peers except for the peer that transmits the synchronization confirmation to the remaining peers.

The peer-to-peer architecture is characterized in that equal computer units (“peers”) exchange data through a network and access their respective copies of databases that are available to all peers.

The synchronization request causes all peers of the computer network that receive the synchronization request to update their respective copies by one of the respective databases.

The transmission of the synchronization request may be implemented advantageously through a standard and cost-effective peer-to-peer client, such as preferably Virtual Office of Groove Networks, Inc. As an alternative, the peer-to-peer clients FolderShare of Byte Taxi, Inc. or BelnSync Ltd. can be used, which also fulfill all conditions for the application of the method according to the invention.

The modification originally executed by at least one of the peers, the author peer, or the modifications of a copy of a database is reconstructed on the basis of the synchronization request by the remaining peers for their respective copies of the database.

By the transmission of synchronization confirmations of all peers meeting the synchronization request it is ensured that the synchronization status of each peer is known, i.e. each user can in principle learn from each computer unit of the network whether and which modifications were executed on the copies of the databases.

According to the inventive method, a server or another somewhat distinguished type of computer unit or a “master copy” of a database is not required for the data replication. The number of peers connected with one another within the network may basically be arbitrary.

The synchronization process, i.e. the replication of all copies of the databases may be carried out permanently, in the background and automatically. Problems do not occur if single peers are temporarily offline. The installation, configuration and application of the method according to the invention can be carried out comparatively unproblematically.

It is a special advantage of the present invention that the actual data transfer between the peers can be implemented through a standard available peer-to-peer client. The method disclosed can therefore be implemented in connection with already existing and well tested as well as cost-effective data transfer solutions without influencing an existing data transfer functionality.

Since the synchronization request as well as the synchronization confirmations are transmitted in the form of files, i.e. the interface of the inventive method to the existing peer-to-peer client is represented by files, the method according to the invention is independent of the intrinsic developments of the peer-to-peer client used which ensures future compatibility.

In a preferred embodiment, the generation and transmission of the synchronization request and/or the synchronization confirmations is carried out automatically according to the inventive method. If the request as well as the confirmation is implemented automatically, a further intervention of the users is not required. Thus, the entire replication method can completely run in the background.

A deletion of data concerning the synchronization request and/or the synchronization confirmations on the at least one peer from which the synchronization request was transmitted advantageously takes place according to the inventive method after the step of generation and transmission of synchronization confirmations.

According to the inventive method, possible conflicts on the level of the data transfer program are substantially avoided, since the synchronization request and the synchronization confirmations transmitted via the file transmission system are subject to the proprietor principle. They are in principle not modified after generation and can only be deleted by the author peer according to the proprietor principle.

For the case that a peer fails and it can no longer delete its own synchronization request or its synchronization confirmations, globally valid rules can advantageously be defined, which identify one of the remaining peers, which carries out the deletion process after the failed peer has failed for a defined period of time.

By deleting the no longer required data, storage space is saved and the status of the original author peer is easily identified.

It can also be desirable that after the step of deleting the data referring to the synchronization request and/or the synchronization confirmations the step of generating deletion information on the at least one peer from which the synchronization request was transferred and the step of transfer of the deletion information from the at least one peer by means of which the deletion information was generated to all other peers take place.

Through this all peers are clearly informed about the termination of replication of the database.

In a practical embodiment the step of transmission of the deletion information comprises the deletion of data through the synchronization request.

In a preferred embodiment of the present invention, the synchronization request comprises the modification of the copy of the database, which was carried out on the at least one peer from which the synchronization request is transmitted, or the modified copy of the database, and this modification or the modified copy is transmitted to the respective copies of all other peers.

While in principle the synchronization request may include a request to the peers to load from the author peer the respective modification of the copy of a database or the respective modified database, it may prove to be more practical and faster to transfer the respective modification directly together with the synchronization request.

It is advantageous to allocate a modification time to the modification of the copy of a database. Through this each modification is clearly identified and may be organized according to time. An advantageous embodiment of the inventive method is based on this temporal organization according to which, in the case a data conflict exists, the peer is identified whose modification of the copy of the database has the youngest modification time, and an elimination of the conflict on the peer identified in this manner takes place.

A data conflict exists if several synchronization requests are issued, which refer to the same dataset, or part of the database, which were not yet processed by at least one peer.

In a P2P network complex conflict scenarios may occur, since several peers may modify and delete datasets offline. An arbitrary amount of peers may for instance modify or delete the same dataset in its copy of the database offline, which may cause a data conflict with an arbitrary amount of synchronization requests.

Data conflicts occurring in this manner cannot only clearly be detected according to the inventive method, but they can also be treated and solved by an efficient proper conflict solution by a pair-wise implementation of the conflicts in the sequence of the modification times.

The pairs are formed by the last modified and another conflicting database copy. The conflict solution is implemented manually or by the aid of a computer at the peer at which the last modification was made.

By the pair-wise implementation/management of the conflicts, the complexity of possible conflicts is minimized to a low amount of possible conflicts, which may be generated at a data conflict with two synchronization requests.

More specifically, conflicts can be treated according to a configurable decision table, which can be adapted by the user according to the requirements of the user. The decision table may be configured such that some types of conflicts are treated and solved by the user and others are treated and solved automatically by the computer according to certain rules.

The user can chose in certain conflicts that a conflict that is actually solved by interaction with the user is always treated and solved in the background by the program according to a proposed rule.

If for instance a user deletes a dataset that another user has modified offline, a conflict is indicated to this user. This user can now select that the file is automatically restored so that this conflict “delete/edit” is never reported to the user again.

In an advantageous embodiment of the inventive method, the modification of the copy of the database on the at least one peer of the peer-to-peer computer network is implemented on the basis of a modification information transmitted by a peer of a further peer-to-peer computer network that physically and/or logically differs from the peer to which the peer belongs on which the modification of the copy of the database takes place.

Particularly, a peer-to-peer computer network may thereby logically be divided into sub-networks and a superordinate network, wherein in each sub-network at least one peer for the transfer of data between the adjoining networks level is defined (transfer peer), and the entirety of the transfer peers of the sub-networks defines the superordinate peer-to-peer network. Modification information between the network levels are exchanged by the transfer peers.

Such an embodiment is particularly advantageous for large peer-to-peer computer networks, since by such a sub-division it can be avoided that the number of replication transactions grow exponentially with the number of peers.

Furthermore, the present invention provides a computer program product which comprises one or a plurality of computer-readable media which include instructions to be implemented by the computer to carry out the method steps of the above-mentioned method for replicating databases in a peer-to-peer computer network.

Exemplary embodiments of the present invention which comprise a serverless replication of databases will be described herebelow by means of the drawing.

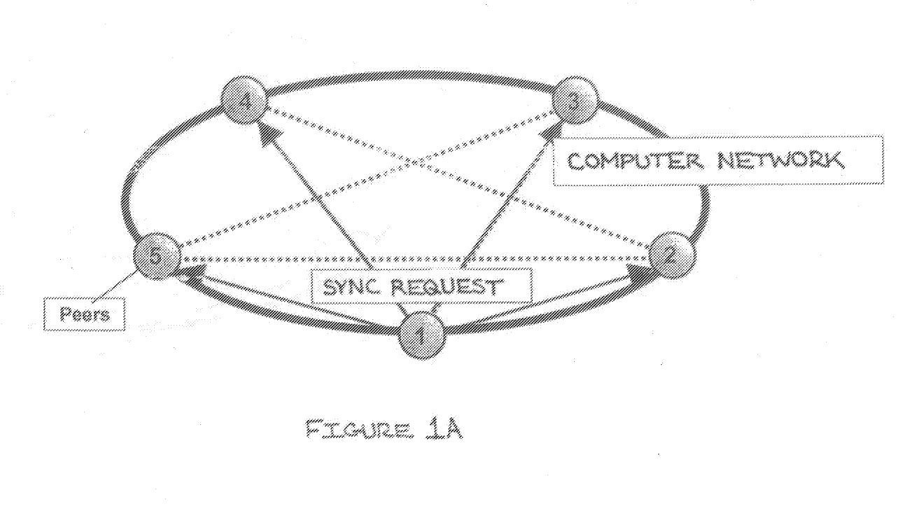

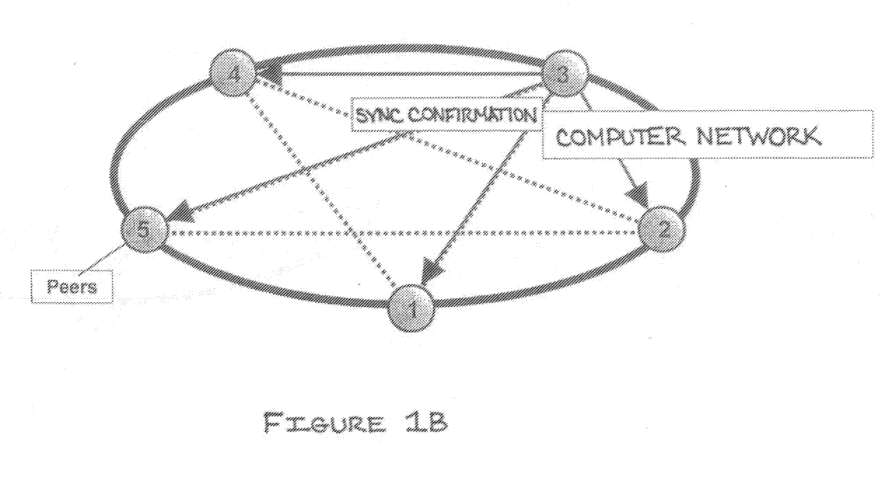

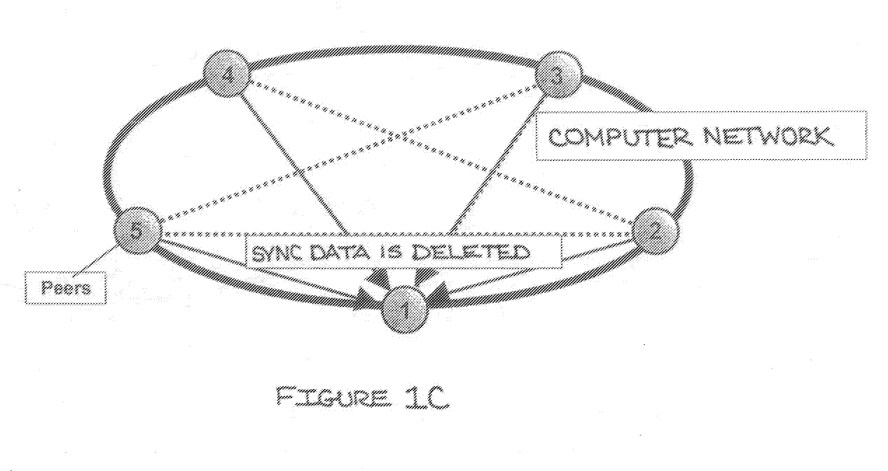

FIGS. 1a to 1d show the inventive method for serverless data replication in peer-to-peer architectures.

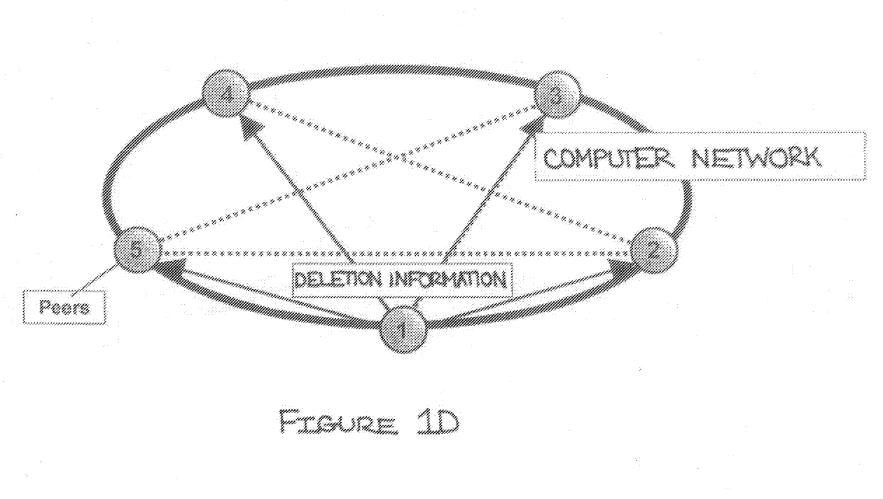

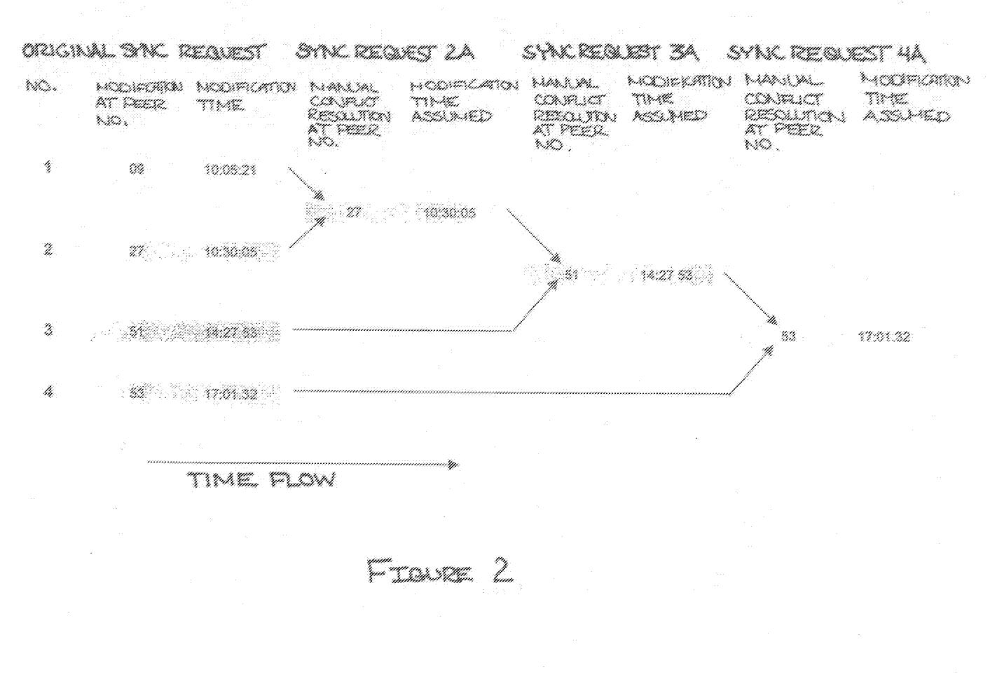

FIG. 2 shows the pairwise conflict solution according to the inventive method in the case of more than two modifications of copies of a database.

FIG. 1a exemplarily shows five computer units linked with one another in a peer-to-peer architecture. The peer numerated by 1 executes a modification at one of its copies and generates a respective synchronization request (sync request), i.e. a modification request, which advantageously already includes the modification itself. For instance, a part of the copy of the database, which includes the modification, or the entire modified copy of the database can be transmitted. This synchronization request is transferred by means of a peer-to-peer client to the four remaining peers. The peer-to-peer client can be an existing software solution for data transfer between linked computer units, such as e.g. Virtual Office of Groove Networks, Inc.

FIG. 1b shows the next step of the method. The remaining peers, and in this case exemplarily particularly peer number 3, receive the synchronization request and, in the case a conflict does not exist and they are online, carry out the respective modification in their respective copies of the respective databases. After the modification was made, peer number 3 generates a synchronization confirmation (sync confirmation), and after the modification is terminated, any other peer which has received a synchronization request from peer number 1 generates a synchronization confirmation. This synchronization confirmation is transmitted to all other peers in a desirable manner automatically by means of the peer-to-peer client.

As shown in FIG. 1c, the data referring both to the synchronization request as well as the synchronization confirmations are deleted after receipt of all synchronization confirmations from peer number 1 which had sent the synchronization request to all remaining peers.

As may be derived from FIG. 1d, peer number 1 generates a deletion information after it has deleted the synchronization data. This deletion information is transferred by the peer-to-peer client e.g. advantageously automatically to the remaining peers, i.e. the deletion of synchronization request data on all remaining peers is caused. By the transfer of the deletion information the method for serverless data replication according to the present invention can be terminated.

It can therefore be ensured by the method described by means of FIGS. 1a to 1d that modification information concerning a copy of a database are available to all peers. The processing status of all peers is also known to all peers.

FIG. 2 illustrates as an example the resolution of a data conflict possibly occurring in the course of data replication. According to the example shown, peer number 9 generates a synchronization request at the time 10.05.21. Time definitions that are more precise are possible of course.

Before all peers of the network have terminated synchronization, peer number 27 transmits a second synchronization request at the time 10:30:05 through the peer-to-peer client to all peers. This second synchronization request causes a data conflict. The modification which is requested by peer number 27 could for instance refer to a data entry that no longer exists due to the modification carried out by peer number 9 or which was postponed or modified in a way that the modification provided by peer number 27 can no longer sensibly be carried out.

Since the younger synchronization request was transmitted by peer number 27 it is identified as the originator of the data conflict. A manual conflict solution by the user of peer number 27 can now be carried out. The time of opposing modification (10:30:05) is temporarily stored as the last modification time.

At the time 14:27:53 a further synchronization request takes place which is transmitted by the peer number 51 to all other peers and which also triggers a data conflict although this data conflict is typically of a different nature. Accordingly, 14:27:53 is taken as the youngest modification time and peer 51 is identified as the originator. The opposing synchronization request is treated accordingly, which is transmitted at 17:01:32 by peer number 53. A conflict chain can gradually be processed clearly by manual conflict solution from originator to originator.

As shown in FIG. 2, it can clearly be recognized at any time when conflicts occur who the originator of a conflict is, i.e. the peer that has performed the last modification. Particularly in the case of several modifications of copies of the same database by any peers, a pair-wise execution and resolution of the conflicts in the sequence of their cause is ensured.

1. Method for replicating a database in a peer-to-peer computer network, comprising
modifying a copy of the database on at least one peer of the peer-to-peer computer network;
generating a synchronization request on the basis of the modified copy of the database on the at least one peer of the peer-to-peer computer network;
transmitting the synchronization request to all other peers of the peer-to-peer computer network;
receiving and executing the synchronization request on all of the other peers;
generating and transmitting synchronization confirmations after executing the synchronization request on all of the other peers to all peers or all peers except for the peer that transmits the synchronization confirmation to the remaining peers.

2. Method as claimed in claim 1, wherein the generation and transmission of the synchronization request and/or the generation and transmission of the synchronization confirmations is carried out automatically.

3. Method as claimed in claim 1, in which after the step of generating and transmitting synchronization confirmations a deletion of the data referring to the synchronization request and/or the synchronization confirmations on the at least one peer by which the synchronization request was transmitted takes place.

4. Method as claimed in claim 3, in which after the step of deleting the data referring to the synchronization request and/or the synchronization confirmations the following steps are carried out:
generating deletion information on the at least one peer which transmitted the synchronization request; and
transmitting the deletion information from the at least one peer through which the deletion information was generated to all other peers.

5. Method as claimed in claim 4, wherein the transmission of the deletion information comprises the deletion of data through the synchronization request.

6. Method as claimed in claim 1, wherein the synchronization request comprises the modification of the copy of the database that was executed on the at least one peer by which the synchronization request is transmitted, or comprises the modified copy of the database, and this modification or the modified copy is transmitted to the respective copies of all other peers.

7. Method as claimed in claim 1, wherein a modification time is allocated to the modification of the copy of the database.

8. Method as claimed in claim 7, wherein, if a data conflict exists, the peer is identified, whose modification of the copy of the database comprises the youngest modification time, and an elimination of the data conflict on the peer identified in this manner takes place.

9. Method as claimed in claim 8, wherein the elimination of the data conflict is carried out pair-wise.

10. Method as claimed in claim 1, wherein
the modification of the copy of the database on the at least one peer of the peer-to-peer computer network is carried out on the basis of a modification information transmitted by a peer of a further peer-to-peer computer network that is physically and/or logically different thereto.

11. Method as claimed in claim 1, wherein the data transmission is carried out by a standard peer-to-peer client.

12. Computer program product comprising one or a plurality of computer-readable media, which include instructions that can be carried out by computers to carry out the steps of the method according to claim 1.

13. Method as claimed in claim 2, in which after the step of generating and transmitting synchronization confirmations a deletion of the data referring to the synchronization request and/or the synchronization confirmations on the at least one peer by which the synchronization request was transmitted takes place.
